(19) United States
(12) Patent Application Publication
(10) Pub. No.: US 2024/0287216 A1
(43) Pub. Date: Aug. 29, 2024

(54) POLYMER DEVOLATILIZATION PROCESS

(71) Applicant: TOTALENERGIES ONETECH BELGIUM, Seneffe (Feluy) (BE)

(72) Inventor: Serge EON, Waterloo (BE)

(73) Assignee: TOTALENERGIES ONETECH BELGIUM, Seneffe (Feluy) (BE)

(21) Appl. No.: 18/572,456

(22) PCT Filed: Jul. 19, 2022
(86) PCT No.: PCT/EP2022/070266

§ 371 Date: Dec. 20, 2023

(30) Foreign Application Priority Data
Jul. 19, 2021 (EP) 21186277.6

(51) Int. Cl. C08F 6/00; C08F 10/02; C08F 12/08; C08G 63/08; C08G 63/90

(52) U.S. Cl. CPC C08F 6/005; C08F 10/02; C08F 12/08; C08G 63/08; C08G 63/90

(57) ABSTRACT

The present invention relates to a process for reducing volatiles in a polymer melt feed. The present invention also relates to a devolatilization apparatus for removing volatiles from a polymer melt feed.

### TECHNICAL FIELD

The present invention in general relates to a process or method for reducing volatiles in a polymer melt feed. The present invention also relates to a devolatilization apparatus for removing volatiles from a polymer melt feed.

### BACKGROUND

During industrial polymerisation, monomer is fed to a polymerisation reactor, optionally accompanied by a co-monomer and/or a solvent. After polymerisation, the final polymer product may comprise undesirable components such as unreacted monomer, co-monomer, or solvent. The polymer may be recovered from a polymerisation reactor and fed to a devolatilization section, where these undesirable components may be removed from the polymer. For example, volatiles may be removed by vacuum distillation, flash devolatilization, stripping, increasing polymer surface area, or combinations thereof. The devolatilization system is usually nowadays composed of two steps: a first one to remove a major portion of the volatiles and a second one to fine tune the removal of volatiles

For the second step, the polymer may be passed through a nozzle, which can be an arrangement of one or more flow tubes having a plurality of small perforations or holes directed downward in a vessel for discharging molten polymer in strands, whereby the nozzle may comprise a variety of shapes, as exemplified in U.S. Pat. No. 7,087,139 B1, U.S. Pat. No. 7,754,849 B2, U.S. Pat. No. 10,058,794 B2, or U.S. Pat. No. 8,241,459 B2. The polymer strands provide increased surface area for devolatilization of the polymer within the vessel. As the strands fall in the devolatilization vessel, the unreacted monomer, co-monomer, and/or solvent may be released while the polymer strands collect at the bottom of the vessel.

The devolatilised polymer may then be sent to subsequent polymer processing steps. Given the commercial and regulatory importance of devolatilization, an ongoing need exists for improved devolatilization processes and associated equipment.

It is therefore an object of the present invention to provide an improved and/or optimised process for reducing volatiles in a polymer melt feed, and an improved and/or optimised apparatus for removing volatiles from a polymer melt feed. It is an object to provide a more efficient process and apparatus without the need for stripping. It is an object to provide a more robust process and apparatus. It is an object to provide a process and apparatus that lowers energy consumption. It is an object to provide a process and apparatus that lowers the ratio of the capital expenditures over the operating expenditures (capex/opex). It is an object to provide a process and apparatus that may be easier to clean and maintain. It is an object to provide a process and apparatus that does not lead to decomposition nor any other substantial modification of the properties of the polymer to be devolatilised.

### SUMMARY OF THE INVENTION

In a first aspect, the present invention thereto provides a process for reducing volatiles in a polymer melt feed in a devolatilization apparatus, the process comprising the steps of:
providing a polymer melt feed to a devolatilization nozzle; the nozzle comprising an inlet part, a polymer distribution part comprising headers, and an outlet part comprising a number of apertures, wherein the polymer melt feed is provided to the inlet part at a temperature T;
passing the polymer melt feed through the apertures, thereby forming polymer strands in a devolatilization vessel;
collecting the polymer strands in a collector by letting the polymer strands drop over a strand drop height into the collector; thereby obtaining a devolatilised polymer in the collector and removed volatiles;
recovering the volatiles through a gas outlet of the devolatilization vessel; and,
recovering the resulting devolatilised polymer from the collector through a polymer outlet of the collector;
preferably characterized in that
   the polymer melt viscosity at temperature T is at least 100 000 cP and at most 5 000 000 cP;
   the average throughput per aperture is at least 5 g/h and at most 100 g/h;
   the average aperture diameter is at least 0.5 mm and at most 8.0 mm; and, the ratio of strand drop height/average aperture diameter is at least 0.5 m/mm to at most 6.0 m/mm.

In some preferred embodiments, the polymer melt viscosity at temperature T is at least 200 000 cP and at most 2 500 000 cP, preferably at least 500 000 cP and at most 2 000 000 cP; preferably at least 750 000 cP and at most 1 500 000 cP; most preferably about 1 000 000 cP.

In some preferred embodiments, the average throughput per aperture is at least 10 g/h and at most 75 g/h; preferably at least 20 g/h and at most 50 g/h; most preferably about 25 g/h; wherein the average throughput per aperture is calculated by dividing the total throughput by the number of apertures.

In some preferred embodiments, the pressure drop across the nozzle is least 2.0 bar and at most 30.0 bar; preferably at least 3.0 bar and at most 15.0 bar; more preferably at least 4.0 bar and at most 10.0 bar; most preferably about 6.0 bar.

In some preferred embodiments, the polymer temperature is at least 150° C. and at most 300° C.; preferably at least 170° C. and at most 280° C.; more preferably at least 190° C. and at most 260° C.; most preferably at least 200° C. and at most 240° C.

In some preferred embodiments, the pressure in the devolatilization vessel outside the nozzle is at least 0.5 mbar abs and at most 500.0 mbar abs; preferably at least 1.0 mbar abs and at most 200.0 mbar abs; more preferably at least 1.2 mbar abs and at most 10.0 mbar abs; most preferably about 1.5 mbar abs.

In some preferred embodiments, the average aperture diameter is at least 0.5 mm and at most 8.0 mm; preferably at least 1.0 mm and at most 6.0 mm; more preferably at least 1.5 mm and at most 4.0 mm; most preferably about 2.0 mm.

In some preferred embodiments, the strand drop height is at least 1.0 m and at most 20.0 m; preferably at least 2.0 m and at most 10.0 m; more preferably at least 4.0 m and at most 8.0 m; most preferably about 6.0 m.

In some preferred embodiments, the ratio of polymer viscosity at temperature T/average aperture diameter is at least 50 000 cp/mm to at most 4 000 000 cp/mm; preferably at least 60 000 cp/mm to at most 2 500 000 cp/mm; preferably at least 80 000 cp/mm to at most 1 500 000 cp/mm; preferably at least 150 000 cp/mm to at most 1 200 000 cp/mm; preferably at least 200 000 cp/mm to at most 1 000 000 cp/mm; preferably at least 400 000 cp/mm to at most 600 000 cp/mm, preferably around 500 000 cp/mm.

In some preferred embodiments, the ratio of strand drop height/average aperture diameter is at least 0.5 m/mm to at most 6.0 m/mm; preferably at least 1.0 m/mm to at most 5.0 m/mm; preferably at least 2.0 m/mm to at most 4.0 m/mm; preferably about 3.0 m/mm.

In some preferred embodiments, the ratio of average distance between adjacent apertures/average aperture diameter is at least 0.5 to at most 10.0; preferably at least 1.0 to at most 5.0; preferably at least 1.5 to at most 4.0; preferably about 2.0.

In some preferred embodiments, the ratio of average throughput per aperture/average aperture diameter is at least at least 2.0 g/h/mm to at most 50.0 g/h/mm; preferably at least 5.0 g/h/mm to at most 30.0 g/h/mm; preferably at least 10.0 g/h/mm to at most 15.0 g/h/mm.

In some preferred embodiments, the polymer melt feed comprises polystyrene or polylactic acid.

In a second aspect, the present invention thereto provides a devolatilization apparatus for removing volatiles from a polymer melt feed, the apparatus configured to perform the process according to the first aspect, and embodiments thereof.

More particularly, the invention provides in a devolatilization apparatus for removing volatiles from a polymer melt feed, the apparatus comprising:
a devolatilization nozzle comprising an inlet part, a polymer distribution part comprising headers, and an outlet part comprising a number of apertures, configured to form polymer strands in a devolatilization vessel;
a collector, configured to collect the polymer strands in the devolatilization vessel;
a polymer outlet, configured to remove the collected polymer from the collector;
and,
a gas outlet, configured to remove the volatiles from the devolatilization vessel;
   wherein the average aperture diameter is at least 0.5 mm and at most 8.0 mm; and,
   wherein the ratio of strand drop height/average aperture diameter is at least 0.5 m/mm to at most 6.0 m/mm.

In some preferred embodiments, the average aperture diameter is at least 0.5 mm and at most 8.0 mm; and the strand drop height is at least 1.0 m and at most 20.0 m.

In a third aspect, the present invention thereto provides a devolatilised polymer, obtained through a process according to the first aspect, and embodiments thereof, or with an apparatus according to the second aspect, and embodiments thereof. The devolatilised polymer preferably comprises a residuals concentration of volatiles at the outlet of at most 3 000 ppm.

The present invention, and embodiments thereof, provides an improved process for reducing volatiles in a polymer melt feed, for example in a second step devolatilization, and an improved apparatus for removing volatiles from a polymer melt feed, for example in a second step devolatilization.

The polymer degassing is very efficient. The polymer distribution inside the nozzle is particularly optimised for efficient degassing. Furthermore, disadvantages of other stripping methods are avoided, swelling is minimised, and the strands are more stable.

The polymer degassing may be so efficient that there is no need for the use of blowing agents or for expanding the polymer during the degassing process, resulting in un-expanded polymer.

Processes for degassing polymers without producing expanded polymers may be favourable as they do not require an extra melt step to obtain degassed un-expanded polymer.

Being able to work at optimised aperture diameters allows for simpler engineering, lower capex and opex.

Being able to work at reduced pressure drops allows for a reduced energy consumption and spares the mechanical integrity of the apparatus.

Being able to work at reduced temperatures allows for a reduced energy consumption and reduces the thermal degradation of the polymer.

The present apparatus also allows for easy cleaning and maintenance.

### DETAILED DESCRIPTION OF THE INVENTION

When describing the invention, the terms used are to be construed in accordance with the following definitions, unless a context dictates otherwise.

As used herein, the singular forms “a”, “an”, and “the” include both singular and plural referents unless the context clearly dictates otherwise. By way of example, “a resin” means one resin or more than one resin.

The terms “comprising”, “comprises” and “comprised of” as used herein are synonymous with “including”, “includes” or “containing”, “contains”, and are inclusive or open-ended and do not exclude additional, non-recited members, elements, or method steps. It will be appreciated that the terms “comprising”, “comprises” and “comprised of” as used herein comprise the terms “consisting of”, “consists” and “consists of”.

The recitation of numerical ranges by endpoints includes all integer numbers and, where appropriate, fractions subsumed within that range (e.g., 1 to 5 can include 1, 2, 3, 4 when referring to, for example, a number of elements, and can also include 1.5, 2, 2.75 and 3.80, when referring to, for example, measurements). The recitation of end points also includes the end point values themselves (e.g., from 1.0 to 5.0 includes both 1.0 and 5.0). Any numerical range recited herein is intended to include all sub-ranges subsumed therein.

All references cited in the present specification are hereby incorporated by reference in their entirety. In particular, the teachings of all references herein specifically referred to are incorporated by reference.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment but may. Furthermore, the particular features, structures or characteristics may be combined in any suitable manner, as would be apparent to a person skilled in the art from this disclosure, in one or more embodiments. Furthermore, while some embodiments described herein include some, but not other, features included in other embodiments, combinations of features of different embodiments are meant to be within the scope of the invention, and form different embodiments, as would be understood by those in the art.

The terms described above, and others used in the specification are well understood to those skilled in the art.

Preferred statements (features) and embodiments, resins and uses of this invention are set herein below. Each statement and embodiment of the invention so defined may be combined with any other statement and/or embodiment unless clearly indicated to the contrary. In particular, any feature indicated as being preferred or advantageous may be combined with any other feature or features or statements indicated as being preferred or advantageous.

Hereto, the present invention is, in particular, captured by any one or any combination of one or more of the below numbered aspects and embodiments, with any other statement and/or embodiment.

The present invention relates to a process for reducing volatiles in a polymer melt feed in a devolatilization apparatus. The process comprises the steps of:
providing a polymer melt feed to a devolatilization nozzle; the nozzle comprising an inlet part, a polymer distribution part comprising headers, and an outlet part comprising a number of apertures;
wherein the polymer melt feed is provided to the inlet part at a temperature T;
passing the polymer melt feed through the apertures, thereby forming polymer strands in a devolatilization vessel;
collecting the polymer strands in a collector by letting the polymer strands drop over a strand drop height into the collector; thereby obtaining a devolatilised polymer in the collector and removed volatiles;
recovering the volatiles through a gas outlet of the devolatilization vessel; and,
recovering the resulting devolatilised polymer from the collector through a polymer outlet of the collector.

Preferably, the polymer melt viscosity at temperature T is at least 100 000 cP and at most 5 000 000 cP; the average throughput per aperture is at least 5 g/h and at most 100 g/h; the average aperture diameter is at least 0.5 mm and at most 8.0 mm; and, the ratio of strand drop height/average aperture diameter is at least 0.5 m/mm to at most 6.0 m/mm.

Preferably, the polymer melt viscosity is at least 100 000 cP and at most 5 000 000 cP, preferably at least 200 000 cP and at most 2 500 000 cP. Preferably, the average throughput per aperture is at least 5 g/h and at most 100 g/h.

The present invention also relates to a devolatilization apparatus for removing volatiles from a polymer melt feed configured to perform the process as described herein, and embodiments thereof.

The present invention also relates to a devolatilization apparatus for removing volatiles from a polymer melt feed, the apparatus comprising:
a devolatilization nozzle comprising an inlet part, a polymer distribution part comprising headers, and an outlet part comprising a number of apertures, configured to form polymer strands in a devolatilization vessel;
a collector, configured to collect the polymer strands in the devolatilization vessel;
a polymer outlet, configured to remove the collected polymer from the collector; and,
a gas outlet, configured to remove the volatiles from the devolatilization vessel.

Preferably for the apparatus, the average aperture diameter is at least 0.5 mm and at most 8.0 mm; and, the ratio of strand drop height/average aperture diameter is at least 0.5 m/mm to at most 6.0 m/mm.

Preferably for the apparatus, the average aperture diameter is at least 0.5 mm and at most 8.0 mm; the strand drop height is at least 1.0 m and at most 20.0 m; and, the ratio of strand drop height/average aperture diameter is at least 0.5 m/mm to at most 6.0 m/mm.

Preferably, the average aperture diameter is at least 0.5 mm and at most 8.0 mm. Preferably, the strand drop height is at least 1.0 m and at most 20.0 m.

The present invention also relates to a process for reducing volatiles in a polymer melt feed using the devolatilization apparatus as described herein, and embodiments thereof.

The present invention also relates to the use of the devolatilization apparatus as described herein, and embodiments thereof, for reducing volatiles in a polymer melt feed.

The present invention also relates to a devolatilised polymer, obtained through a process as described herein, and embodiments thereof, or with an apparatus as described herein, and embodiments thereof. The devolatilised polymer preferably comprises a residuals concentration of volatiles at the outlet of at most 3 000 ppm.

The devolatilization process or apparatus may be used to remove the volatile components from a polymer prior to further polymer manufacturing processes such as pelletising and forming.

The inventors have found that a particular set of process parameters may provide an optimum for polymer devolatilization. Preferably the process is performed at these values and/or the apparatus is configured to operate at these values.

In some preferred embodiments, the polymer melt viscosity is at least 100 000 cP and at most 5 000 000 cP: preferably at least 200 000 cP and at most 2 500 000 cP; preferably at least 500 000 cP and at most 2 000 000 cP; more preferably at least 750 000 cP and at most 1 500 000 cP; most preferably about 1 000 000 cP. The polymer melt viscosity may be measured using commercial rheometer. For non-Newtonian polymers, the polymer viscosity may be measured by a curve vs shear rate. For example, the viscosity may be measured using a capillary rheometer Rosand, with a die of diameter 1 mm and length 16 mm, optionally by applying the corrections of Bagley and Rabinowitch.

The inventors have found that this viscosity provides an optimum for the devolatilization of the polymer. Higher viscosities result in a higher pressure drop across the nozzle, and a higher amount of residual volatiles. Lower viscosities typically require higher temperatures leading to more thermal degradation. Viscosities that are too low lead to a too low pressure drop and risk of preferential path across the nozzle which is detrimental to the devolatilization efficiency.

For polymers for which lower viscosities can be more easily obtained, a smaller aperture diameter is preferably used.

In some preferred embodiments, the average throughput per aperture is at least 5 g/h and at most 100 g/h; preferably at least 10 g/h and at most 75 g/h; more preferably at least 20 g/h and at most 50 g/h; most preferably about 25 g/h. The average throughput per aperture may be calculated by dividing the total throughput by the number of apertures.

The inventors have found that this throughput per aperture provides an optimum for the devolatilization of the polymer when considering not only volatiles removal efficiency but also capex and opex. Higher throughputs result in a higher pressure drop across the nozzle, and a higher amount of residual volatiles. However, if the throughput per aperture is lower, the required number of holes is so big than the vessel requires an excessive diameter.

In some preferred embodiments, the pressure drop across the nozzle is at least 2.0 bar and at most 30.0 bar; preferably at least 3.0 bar and at most 15.0 bar; more preferably at least 4.0 bar and at most 10.0 bar; most preferably about 6.0 bar. The pressure drop may be measured by providing pressure sensors at the entrance of the nozzle and in the devolatilization vessel, which would allow to know the overall pressure drop. Knowing the viscosity vs shear rate curve, one can then deduct the pressure drop across the apertures considering the nozzle internal geometry. A pressure sensor may also be installed at the upstream transfer pump discharge, which allows to make a fitting of the viscosity calculation since it provides the pressure drop across the transfer pipe to the nozzle.

The inventors have found that this pressure drop provides an optimum for the devolatilization of the polymer. The higher the pressure drop, the thicker the nozzle needs to be—which causes a higher pressure drop in itself—and the more energy is required to push the polymer through the nozzle. If the pressure drop across the apertures is too low, then there is a risk of preferential path in the nozzle, which is detrimental to the devolatilization efficiency.

Excessive pressure drop results in increased opex (operating expenditures) and capex (capital expenditures) since it may require more powerful pumps and increased metal thickness of the devolatilization apparatus. An increased thickness would further also result in increased pressure drop since the polymer would have to travel a longer path through the apertures.

In some preferred embodiments, the polymer temperature is at least 150° C. and at most 300° C.; preferably at least 170° C. and at most 280° C.; more preferably at least 190° C. and at most 260° C.; most preferably at least 200° C. and at most 240° C. It is to be noted that optimum temperature varies from one type of polymer to the other, as well as, for a given type of polymer, from one grade to another. The range provided here usually correspond to the targeted viscosity ranges mentioned above. The polymer temperature may be measured by a thermowell temperature probe at the nozzle entrance, i.e. the inlet part. For example, the temperature may be measured using a thermowell type sensor from WIKA model TW10.

The inventors have found that this temperature provides an optimum for the devolatilization of most of the commodity polymers. Although one might think that higher temperatures as such might result in a better devolatilization efficiency, it means also higher risk of thermal degradation. Also, higher temperature typically results in lower viscosity, lower pressure drop across the nozzle, and a risk of less efficient devolatilization. If the temperature is lower, then it means lower devolatilization efficiency, and due to high viscosity higher capex and opex.

Excessive temperature results in the modification of the polymer properties, which is not desirable. The temperature is preferably adapted depending on the stability of the polymer, its viscosity, and the nature of volatiles to be removed.

In some preferred embodiments, the pressure in the devolatilization vessel outside the nozzle is at least 0.5 mbar abs and at most 500.0 mbar abs; preferably at least 1.0 mbar abs and at most 200.0 mbar abs; more preferably at least 1.2 mbar abs and at most 10.0 mbar abs; most preferably about 1.5 mbar abs. The pressure in the devolatilization vessel may be measured by membrane pressure sensors in the vessel. For example, the pressure may be measures using a pressure transmitter coupled with a diaphragm seal from WIKA Model 990.27.

The inventors have found that this pressure provides an optimum for the devolatilization of the polymer. Higher pressures result in a higher amount of residual volatiles. Lower pressure is better for devolatilization efficiency but also requires higher capex and opex. The preferred pressure ranges provided herein are an optimum.

Lower pressures result in excessive energy consumption, while the gain in terms of volatile removal is less significant. In addition, very low pressures, e.g., less than 1 mbar abs, which might be achieved using unconventional and expensive technologies, are not commonly used in industry. As a result, it is preferable that two or three successive devolatilization vessels are used when improved devolatilization is desired.

The nozzle is intended to convey the polymer containing the volatiles from an upstream process to the vessel interior for devolatilization. A plurality of lateral, substantially parallel flow tubes may form an assembly, for example a nozzle assembly.

In some embodiments, the distribution nozzle comprises a perforated flow tube, herein also referred to as a pipe. The perforated tube may be formed by perforating a pre-existing tube or by reconstituting a tube shape using perforated sheets. Alternative shapes are known in the art, as exemplified in U.S. Pat. No. 7,087,139 B1, U.S. Pat. No. 7,754,849 B2, U.S. Pat. No. 10,058,794 B2, or U.S. Pat. No. 8,241,459 B2.

In some embodiments, the devolatilization apparatus comprises a plurality of lateral flow tubes (“flow tubes”), for example as described in WO2008/036523, incorporated herein by reference. The diameter of the pipes may depend on the output of the line. For example, for 3 to 30 T/h, the pipe diameter may be preferred of at least 6″ to at most 18″; preferably at least 8″ to at most 16″; preferably at least 10″ to at most 14″; for example, around 12″ (12 inches). The length of the pipes may also depend on the output of the line. For example, for 3 to 30 T/h, the pipe length may be preferred of at least 1 m to at most 10 m; preferably from at least 2 m to at most 8 m; preferably from at least 3 m to at most 6 m; for example, about 4 m.

In some preferred embodiments, the apertures are arranged in a pitch selected from a group comprising: a triangular or isometric pitch, a square pitch, or a lozenge pitch.

In some embodiments, the apertures are identical in size and/or shape. In some embodiments, the apertures are not identical in size and/or shape.

Sizes and shapes of apertures, as well as methods for producing them, may be found in U.S. Pat. No. 7,754,849 B2 and U.S. Pat. No. 10,058,794 B2, hereby incorporated by reference.

In some preferred embodiments, the apertures are tapered apertures, for example created by a water jet.

Molten polymer is preferably fed to the polymer devolatilization apparatus wherein the polymer is formed into strands upon exiting the flow tubes nozzle through the apertures and the volatiles exit the polymer strands as they descend due to gravity. The polymer strands extend downward into the collector and form a molten mass of devolatilised polymer in the collector of the vessel. The devolatilised polymer exits the collector via the polymer outlet, which, with usually the action of a transfer pump may transmit the devolatilised polymer to a finishing operation such as a pelletizer.

The polymer outlet may be connected at or near the bottom of the vessel and may be used to convey the devolatilized polymer to downstream processing units. The polymer outlet may comprise one or more pipes, connections, or pipes and connections to facilitate polymer collection or to reduce the required pump size.

The gas outlet may be connected at or near the top of the vessel and is used to remove the volatiles that exit the polymer within the vessel. The gas outlet may comprise one or more pipes, connections, or pipes and connections in order to balance vapor flows.

Elements of the apparatus are preferably composed of a material capable of withstanding a differential pressure as well as an elevated operating temperature. Without intending to be limiting, an example of a suitable material may be steel. In case the polymer material may cause corrosion, appropriate steel alloys may be used, such as 316L or duplex steel grades when PLA is the polymer to be devolatilised. Elements of the apparatus may optionally comprise additional elements such as insulation or reinforcement plating.

The inventors have found that a particular set of geometrical parameters may provide an optimum for polymer devolatilization. Preferably the process is performed with an apparatus at these values.

In some preferred embodiments, the average aperture diameter is at least 0.5 mm and at most 8.0 mm; preferably at least 1.0 mm and at most 6.0 mm; more preferably at least 1.5 mm and at most 4.0 mm; most preferably about 2.0 mm.

The inventors have found that this diameter provides an optimum for the devolatilization of the polymer, particularly when also considering the capex and opex. Larger diameters result in a lower pressure drop and a lower devolatilization efficiency (a higher amount of residual volatiles). Smaller diameters may result in higher pressure drop or might even risk blocking of the aperture. The increased pressure drop as a result may reach the maximum mechanical resistance of the nozzle. At very low aperture diameters, drag forces result in excessive pressure drop, with excessive energy consumption as a result.

Furthermore, the strands may sway while dropping into the collector. Swaying comes from the gas stream constituted by volatiles leaving the strands. Bigger strands are less prone to swaying, while less gas flow perturbation occurs as the free strand surface is lower.

When comparing a bundle of small diameter strands with a bundle of big diameter strands, for a defined polymer flowrate and a defined surface of holes, the bundle of big strands was found to present less swaying, thereby enabling longer falling course, while devolatilisation was less efficient and pressure drop was lower. If a longer falling course is foreseen with big strands to improve volatile removal, it will result in higher capex since bigger devolatilising vessels will be required. The present preferred operating ranges result in higher devolatilisation.

In some preferred embodiments, the strand drop height is at least 1.0 m and at most 20.0 m; preferably at least 2.0 m and at most 10.0 m; more preferably at least 4.0 m and at most 8.0 m; most preferably about 6.0 m.

The inventors have found that this drop height provides an optimum for the devolatilization of the polymer. If the drop height is too low, then there devolatilization efficiency is reduced. If the drop height is too high, as the strands move a bit they may lump together. The values given are then an optimum when considering devolatilization efficiency.

In some preferred embodiments, the average distance between adjacent apertures is at least 2.0 and at most 12.0 mm; preferably at least 2.5 and at most 10.0 mm; more preferably at least 3.0 and at most 6.0 mm; most preferably about 4.0 mm.

The inventors have found that this distance provides an optimum for the devolatilization of the polymer. If the average distance between adjacent apertures is too low, then the strands might lump together. If the average distance between adjacent apertures is too high, then the required vessel diameter will become excessive for a similar throughput per aperture.

The inventors have found that a set of particular parameters may be intertwined. The inventors have found that a set of particular ratios of parameters provide an optimum for polymer devolatilization. Preferably the process is performed at these values and/or the apparatus is configured to operate at these values.

In some preferred embodiments, the ratio of polymer viscosity/average aperture diameter is at least 50 000 cp/mm to at most 4 000 000 cp/mm; preferably at least 60 000 cp/mm to at most 2 500 000 cp/mm; preferably at least 80 000 cp/mm to at most 1 500 000 cp/mm; preferably at least 150 000 cp/mm to at most 1 200 000 cp/mm; preferably at least 200 000 cp/mm to at most 1 000 000 cp/mm; preferably at least 400 000 cp/mm to at most 600 000 cp/mm, preferably around 500 000 cp/mm.

The inventors have found that this ratio provides an optimum for polymer devolatilization. For a given temperature, there is a curve that describes the viscosity vs the shear rate. In the present invention, for a given flow rate per aperture, the hole diameter will make the shear rate vary, so the hole diameter affects the viscosity. A too high viscosity to aperture diameter ratio would result in excessive pressure drop, and a too low ratio is a sign of poor capex/opex optimization. Without willing to be bound by theory, it is anticipated that high shear rate might result in increased rearrangement of polymer chains within the strands and improving efficiency of the release of volatiles.

In some preferred embodiments, the ratio of strand drop height/average aperture diameter is at least 0.5 m/mm to at most 6.0 m/mm; preferably at least 1.0 m/mm to at most 5.0 m/mm; preferably at least 2.0 m/mm to at most 4.0 m/mm; preferably about 3.0 m/mm.

The inventors have found that this ratio provides an optimum for polymer devolatilization. A too low ratio will result in a poor devolatilization efficiency, and a too high ratio might end up in strands lumping together hence also a poor devolatilization efficiency.

In some preferred embodiments, the ratio of average distance between adjacent apertures/average aperture diameter is at least 0.5 to at most 10.0; preferably at least 1.0 to at most 5.0; preferably at least 1.5 to at most 4.0; preferably about 2.0.

The inventors have found that this ratio provides an optimum for polymer devolatilization. A too low ratio will end up into strand lumping hence a low devolatilization efficiency. A too high ratio means a non-optimized capex.

In some preferred embodiments, the ratio of average throughput per aperture/average aperture diameter is at least 2.0 g/h/mm to at most 50.0 g/h/mm; preferably at least 5.0 g/h/mm to at most 30.0 g/h/mm; preferably at least 10.0 g/h/mm to at most 15.0 g/h/mm.

The inventors have found that this ratio provides an optimum for polymer devolatilization. A too low ratio will mean a non-optimized capex and a too high ratio will end up in a too high pressure drop.

As used herein, the term “residuals concentration” refers to the total concentration of left-over monomer, co-monomer, and/or solvent remaining in the polymer. As used herein, the term “monomer concentration” refers to the concentration of left-over monomer remaining in the polymer.

For example, for polystyrene (PS), the term “residuals concentration” may refer to the total concentration of styrene monomer and ethylbenzene. For example, for polylactic acid (PLA), the term “residuals concentration” may refer to lactide.

In some preferred embodiments, particularly wherein the polymer is polystyrene, the polymer melt feed comprises a residuals concentration at the inlet of at least 1 000 ppm to at most 30 000 ppm; preferably at least 1 500 ppm to at most 20 000 ppm; more preferably at least 2 000 ppm to at most 15 000 ppm; most preferably about 10 000 ppm. The upper values may be relevant when the residuals comprise oligomers.

In some preferred embodiments, particularly wherein the polymer is polystyrene, the polymer melt feed comprises a monomer concentration at the inlet of at least 1 000 ppm to at most 5 000 ppm; preferably at least 1 500 ppm to at most 4 000 ppm; more preferably at least 2 000 ppm to at most 3 000 ppm; most preferably about 2 500 ppm.

In some preferred embodiments, particularly wherein the polymer is polylactic acid, the polymer melt feed comprises a residuals concentration at the inlet of at least 1 000 ppm to at most 50 000 ppm; preferably at least 5 000 ppm to at most 25 000 ppm; more preferably at least 10 000 ppm to at most 20 000 ppm; most preferably about 15 000 ppm.

In some preferred embodiments, particularly wherein the polymer is polylactic acid, the polymer melt feed comprises a monomer concentration at the inlet of at least 1 000 ppm to at most 30 000 ppm; preferably at least 5 000 ppm to at most 25 000 ppm; more preferably at least 10 000 ppm to at most 20 000 ppm; most preferably about 15 000 ppm.

In some preferred embodiments, particularly wherein the polymer is polystyrene, the devolatilised polymer comprises a residuals concentration of volatiles at the outlet of at most 10 000 ppm; preferably at most 7 500 ppm; preferably at most 5 000 ppm. The upper values may be relevant when the residuals comprise oligomers.

In some preferred embodiments, particularly wherein the polymer is polystyrene, the devolatilised polymer comprises a monomer concentration of volatiles at the outlet of at most 1 000 ppm; preferably at most 750 ppm; preferably most 500 ppm; preferably at most 300 ppm.

In some preferred embodiments, particularly wherein the polymer is polylactic acid, the devolatilised polymer comprises a residuals concentration of volatiles at the outlet of at most 3 000 ppm; preferably at most 2 000 ppm; preferably most 1 500 ppm; preferably at most 1 000 ppm.

In some preferred embodiments, particularly wherein the polymer is polylactic acid, the devolatilised polymer comprises a residuals concentration of volatiles at the outlet of at most 3 000 ppm; preferably at most 2 000 ppm; preferably most 1 500 ppm; preferably at most 1 000 ppm.

In some preferred embodiments, the residual concentration of volatiles at the polymer outlet is at most 40% of the residual concentration of volatiles at the inlet; preferably at most 20%; more preferably at most 10%; most preferably at most 5%.

In some embodiments, the polymer is passed once through the devolatilization apparatus. In some embodiments, the polymer is passed multiple times through the devolatilization apparatus. This allows for a further reduction of residuals content in the final polymer.

In some preferred embodiments, the polymer melt feed comprises a polymer selected from the group comprising: polystyrene, polylactic acid, polyester, polyamide, or polyolefin.

In some preferred embodiments, the polymer melt feed comprises polystyrene (PS) or polylactic acid (PLA).

In some preferred embodiments, the polymer melt feed comprises a block co-polymer or a polymer blend, for example a polyolefin elastomer blend.

Some embodiments of the invention may be disclosed in one or a combination of the following statements:
1. Process for reducing volatiles in a polymer melt feed in a devolatilization apparatus, the process comprising the steps of:
   providing a polymer melt feed to a devolatilization nozzle; the nozzle comprising an inlet part, a polymer distribution part comprising headers, and an outlet part comprising a number of apertures;
   passing the polymer melt feed through the apparatus, thereby forming polymer strands in a devolatilization vessel;
   collecting the polymer strands in a collector by letting the polymer strands drop over a strand drop height into the collector; thereby obtaining a devolatilised polymer in the collector and removed volatiles;
   recovering the volatiles through a gas outlet of the devolatilization vessel; and,
   recovering the resulting devolatilised polymer from the collector through a polymer outlet of the collector;
   wherein,
      the polymer melt viscosity is at least 100 000 cP and at most 5 000 000 cP; and,
      the average throughput per aperture is at least 5 g/h and at most 100 g/h.
2. Process according to statement 1 or according to some embodiments herein, wherein the polymer melt viscosity is at least 200 000 cP and at most 2 500 000 cP, preferably at least 500 000 cP and at most 2 000 000 cP; preferably at least 750 000 cP and at most 1 500 000 cP; most preferably about 1 000 000 cP.
3. Process according to any one of the preceding statements or according to some embodiments herein, wherein the average throughput per aperture is at least 10 g/h and at most 75 g/h; preferably at least 20 g/h and at most 50 g/h; most preferably about 25 g/h; wherein the average throughput per aperture is calculated by dividing the total throughput by the number of apertures.
4. Process according to any one of the preceding statements or according to some embodiments herein, wherein the pressure drop across the nozzle is least 2.0 bar and at most 30.0 bar; preferably at least 3.0 bar and at most 15.0 bar; more preferably at least 4.0 bar and at most 10.0 bar; most preferably about 6.0 bar.
5. Process according to any one of the preceding statements or according to some embodiments herein, wherein the polymer temperature is at least 150° C. and at most 300° C.; preferably at least 170° C. and at most 280° C.; more preferably at least 190° C. and at most 260° C.; most preferably at least 200° C. and at most 240° C.
6. Process according to any one of the preceding statements or according to some embodiments herein, wherein the pressure in the devolatilization vessel outside the nozzle is at least 0.5 mbar abs and at most 500.0 mbar abs; preferably at least 1.0 mbar abs and at most 200.0 mbar abs; more preferably at least 1.2 mbar abs and at most 10.0 mbar abs; most preferably about 1.5 mbar abs.
7. Process according to any one of the preceding statements or according to some embodiments herein, wherein the average aperture diameter is at least 0.5 mm and at most 8.0 mm; preferably at least 1.0 mm and at most 6.0 mm; more preferably at least 1.5 mm and at most 4.0 mm; most preferably about 2.0 mm.
8. Process according to any one of the preceding statements or according to some embodiments herein, wherein the strand drop height is at least 1.0 m and at most 20.0 m; preferably at least 2.0 m and at most 10.0 m; more preferably at least 4.0 m and at most 8.0 m; most preferably about 6.0 m.
9. Process according to any one of the preceding statements or according to some embodiments herein, wherein the ratio of polymer viscosity/average aperture diameter is at least 50 000 cp/mm to at most 4 000 000 cp/mm; preferably at least 60 000 cp/mm to at most 2 500 000 cp/mm; preferably at least 80 000 cp/mm to at most 1 500 000 cp/mm; preferably at least 150 000 cp/mm to at most 1 200 000 cp/mm; preferably at least 200 000 cp/mm to at most 1 000 000 cp/mm; preferably at least 400 000 cp/mm to at most 600 000 cp/mm, preferably around 500 000 cp/mm.
10. Process according to any one of the preceding statements or according to some embodiments herein, wherein the ratio of strand drop height/average aperture diameter is at least 0.5 m/mm to at most 6.0 m/mm; preferably at least 1.0 m/mm to at most 5.0 m/mm; preferably at least 2.0 m/mm to at most 4.0 m/mm; preferably about 3.0 m/mm.
11. Process according to any one of the preceding statements or according to some embodiments herein, wherein the ratio of average distance between adjacent apertures/average aperture diameter is at least 0.5 to at most 10.0; preferably at least 1.0 to at most 5.0; preferably at least 1.5 to at most 4.0; preferably about 2.0.
12. Process according to any one of the preceding statements or according to some embodiments herein, wherein the ratio of average throughput per aperture/average aperture diameter is at least at least 2.0 g/h/mm to at most 50.0 g/h/mm; preferably at least 5.0 g/h/mm to at most 30.0 g/h/mm; preferably at least 10.0 g/h/mm to at most 15.0 g/h/mm.
13. Process according to any one of the preceding statements or according to some embodiments herein, wherein the polymer melt feed comprises polystyrene or polylactic acid.
14. Devolatilization apparatus for removing volatiles from a polymer melt feed, the apparatus configured to perform the process according to any one of statements 1 to 13 or according to some embodiments herein; preferably wherein the average aperture diameter is at least 0.5 mm and at most 8.0 mm and the strand drop height is at least 1.0 m and at most 20.0 m.
15. Devolatilised polymer, obtained through a process according to any one of statements 1 to 13 or according to some embodiments herein, or with an apparatus according to statement 14 or according to some embodiments herein, the devolatilised polymer preferably comprising a residuals concentration of volatiles at the outlet of at most 3 000 ppm.

### EXAMPLES

The following examples serve to merely illustrate the invention and should not be construed as limiting its scope in any way. While the invention has been shown in only some of its forms, it should be apparent to those skilled in the art that it is not so limited but is susceptible to various changes and modifications without departing from the scope of the invention.

Polystyrene (Examples 1-6) was devolatilised using the parameters as described in Table 1. Non-preferred values are denoted with an asterisk.

TABLE 1

| | Units | Example 1 | Example 2 | Example 3 |
|---|---|---|---|---|
| Throughput | g/h/aperture | 600* | 10 | 30 |
| Viscosity at temperature T | cP at 10 sec⁻¹ | 1 150 000 | 950 000 | 1 150 000 |
| Devolatiliser pressure | mbar abs | 3 | 2 | 5 |
| Aperture diameter | mm | 4* | 1.2 | 2 |
| Inlet pressure | bar g | 2 | 14* | 4 |
| Temperature (T) | ° C. | 220 | 235 | 220 |
| Drop height | m | 3* | 6 | 5 |
| Aperture distance | mm | 10 | 4 | 4 |
| Inlet residual styrene | ppm wt | 2400 | 2300 | 2450 |
| Outlet residual styrene | ppm wt | 450 | 210 | 290 |

| | Example 4 | Example 5 | Example 6 |
|---|---|---|---|
| Throughput | 100* | 100 | 30 |
| Viscosity at temperature T | 1 250 000 | 1 250 000 | 1 250 000 |
| Devolatiliser pressure | 6 | 6 | 6 |
| Aperture diameter | 2 | 2 | 4* |
| Inlet pressure | 7 | 7 | 1 |
| Temperature (T) | 215 | 214 | 215 |
| Drop height | 5 | 5 | 5 |
| Aperture distance | 4 | 3* | 6 |
| Inlet residual styrene | 2450 | 2500 | 2500 |
| Outlet residual styrene | 380 | 650 | 410 |

PLA (Example 7) and HDPE (Example 8) were devolatilised using the parameters as described in Table 2. Non-preferred values are denoted with an asterisk.

TABLE 2

| | Units | Example 7 | Example 8 |
|---|---|---|---|
| Throughput | g/h/aperture | 40 | 20 |
| Viscosity at temperature T | cP at 10 sec⁻¹ | 900 000 | 4 100 000 |
| Devolatiliser pressure | mbar abs | 4 | 5 |
| Aperture diameter | mm | 2 | 1.2 |
| Inlet pressure | bar g | 5 | 15 |
| Temperature (T) | ° C. | 210 | 260 |
| Drop height | m | 3 | 6 |
| Aperture distance | mm | 4 | 4 |
| Inlet residual styrene | ppm wt | 15000 | 1350 |
| Outlet residual styrene | ppm wt | 2000 | 75 |

1-15. (canceled)

16. Process for reducing volatiles in a polymer melt feed in a devolatilization apparatus, the process comprising the steps of:
providing a polymer melt feed to a devolatilization nozzle; the nozzle comprising an inlet part, a polymer distribution part comprising headers, and an outlet part comprising a number of apertures,
wherein the polymer melt feed is provided to the inlet part at a temperature T;
passing the polymer melt feed through the apertures, thereby forming polymer strands in a devolatilization vessel;
collecting the polymer strands in a collector by letting the polymer strands drop over a strand drop height into the collector; thereby obtaining a devolatilised polymer in the collector and removed volatiles;
recovering the volatiles through a gas outlet of the devolatilization vessel; and,
recovering the resulting devolatilised polymer from the collector through a polymer outlet of the collector;
characterized in that
the polymer melt viscosity at temperature T is at least 100 000 cP and at most 5 000 000 cP, wherein the polymer melt viscosity is measured using a capillary rheometer Rosand with a die of 1 mm diameter and 16 mm length;
the average throughput per aperture is at least 5 g/h and at most 100 g/h;
the average aperture diameter is at least 0.5 mm and at most 8.0 mm; and,
the ratio of strand drop height/average aperture diameter is at least 1.0 m/mm to at most 6.0 m/mm.

17. Process according to claim 16, wherein the polymer melt viscosity at temperature T is at least 200 000 cP and at most 2 500 000 cP, preferably at least 500 000 cP and at most 2 000 000 cP; preferably at least 750 000 cP and at most 1 500 000 cP; most preferably 1 000 000 cP.

18. Process according to claim 16, wherein the average throughput per aperture is at least 10 g/h and at most 75 g/h; preferably at least 20 g/h and at most 50 g/h; most preferably 25 g/h; wherein the average throughput per aperture is calculated by dividing the total throughput by the number of apertures.

19. Process according to claim 16, wherein the pressure drop across the nozzle is least 2.0 bar and at most 30.0 bar; preferably at least 3.0 bar and at most 15.0 bar; more preferably at least 4.0 bar and at most 10.0 bar; most preferably 6.0 bar.

20. Process according to claim 16, wherein the polymer temperature is at least 150° C. and at most 300° C.; preferably at least 170° C. and at most 280° C.; more preferably at least 190° C. and at most 260° C.; most preferably at least 200° C. and at most 240° C.

21. Process according to claim 16, wherein the pressure in the devolatilization vessel outside the nozzle is at least 0.5 mbar abs and at most 500.0 mbar abs; preferably at least 1.0 mbar abs and at most 200.0 mbar abs; more preferably at least 1.2 mbar abs and at most 10.0 mbar abs; most preferably 1.5 mbar abs.

22. Process according to claim 16, wherein the average aperture diameter is at least 1.0 mm and at most 6.0 mm; more preferably at least 1.5 mm and at most 4.0 mm; most preferably 2.0 mm.

23. Process according to claim 16, wherein the strand drop height is at least 1.0 m and at most 20.0 m; preferably at least 2.0 m and at most 10.0 m; more preferably at least 4.0 m and at most 8.0 m; most preferably 6.0 m.

24. Process according to claim 16, wherein the ratio of polymer viscosity at temperature T/average aperture diameter is at least 50 000 cp/mm to at most 4 000 000 cp/mm; preferably at least 60 000 cp/mm to at most 2 500 000 cp/mm; preferably at least 80 000 cp/mm to at most 1 500 000 cp/mm; preferably at least 150 000 cp/mm to at most 1 200 000 cp/mm; preferably at least 200 000 cp/mm to at most 1 000 000 cp/mm; preferably at least 400 000 cp/mm to at most 600 000 cp/mm, preferably 500 000 cp/mm.

25. Process according to claim 16, wherein the ratio of strand drop height/average aperture diameter is at least 1.0 m/mm to at most 5.0 m/mm; preferably at least 2.0 m/mm to at most 4.0 m/mm; preferably 3.0 m/mm.

26. Process according to claim 16, wherein the ratio of average distance between adjacent apertures/average aperture diameter is at least 0.5 to at most 10.0; preferably at least 1.0 to at most 5.0; preferably at least 1.5 to at most 4.0; preferably 2.0.

27. Process according to claim 16, wherein the ratio of average throughput per aperture/average aperture diameter is at least at least 2.0 g/h/mm to at most 50.0 g/h/mm; preferably at least 5.0 g/h/mm to at most 30.0 g/h/mm; preferably at least 10.0 g/h/mm to at most 15.0 g/h/mm.

28. Process according to claim 16, wherein the polymer melt feed comprises polystyrene or polylactic acid.

29. Process according to claim 16, wherein the apertures are arranged in a pitch selected from a group comprising: a triangular or isometric pitch, a square pitch, or a lozenge pitch.

30. Devolatilization apparatus for removing volatiles from a polymer melt feed, the apparatus configured to perform the process according to claim 16; and wherein the apparatus comprises
a devolatilization nozzle comprising an inlet part, a polymer distribution part comprising headers, and an outlet part comprising a number of apertures, configured to form polymer strands in a devolatilization vessel;
a collector, configured to collect the polymer strands in the devolatilization vessel;
a polymer outlet, configured to remove the collected polymer from the collector; and,
a gas outlet, configured to remove the volatiles from the devolatilization vessel,
wherein the average throughput per aperture is at least 5 g/h and at most 100 g/h; wherein the average aperture diameter is at least 0.5 mm and at most 8.0 mm; and,
wherein the ratio of strand drop height/average aperture diameter is at least 1.0 m/mm to at most 6.0 m/mm.
